(19) United States
(12) Patent Application Publication
(10) Pub. No.: US 2015/0300535 A1
(43) Pub. Date: Oct. 22, 2015

(54) PIPE

(71) Applicant: HITACHI ZOSEN CORPORATION, Osaka (JP)

(72) Inventors: Donghui MA, Osaka (JP); Satoshi ASHIDA, Osaka (JP); Jun OKADA, Osaka (JP); Shunsuke KANAGAWA, Osaka (JP); Keita YANAGIHARA, Osaka (JP); Kazuya ETOU, Osaka (JP); Hiroaki ARAI, Osaka (JP)

(21) Appl. No.: 14/387,427

(22) PCT Filed: Mar. 25, 2013
(86) PCT No.: PCT/JP2013/058602

§ 371 Date: Sep. 23, 2014

(30) Foreign Application Priority Data
Mar. 29, 2012 (JP) 2012-075697

(51) Int. Cl. F16L 9/12; F16L 15/00

(52) U.S. Cl. CPC F16L 9/12; F16L 15/00

(57) ABSTRACT

A pipe with a pipe main body made from fiber reinforced plastic and a connection portion made from resin and having substantially tubular shape, into which an end portion of the pipe main body is inserted, thereby being fixed to the end portion. The connection portion includes an annular cover portion that covers an end face of the pipe main body, and an external tapered male screw portion. When the pipe main body is connected to another pipe main body, the male screw portion is screwed with a substantially tubular tapered female screw portion of a coupling. The pipe has a tubular-shaped front-end protrusion located beyond a front-end portion of the male screw portion. The front-end protrusion includes a region of the pipe main body. The entire circumferential region of the pipe in the vicinity of the front-end portion is reinforced by the front-end protrusion.

### TECHNICAL FIELD

The present invention relates to a pipe.

### BACKGROUND ART

Conventionally, when one pipe is connected to another pipe, a joint structure has been used in which a tapered male screw portion that is formed on an external surface of the pipes and a tapered female screw portion that is formed on an internal surface of a substantially tubular-shaped coupling are screwed together (see JP S37-9634B, for example). A pipe that is made from fiber reinforced plastic has also been used conventionally. In the case of such a pipe, an end portion of a pipe main body that is made from fiber reinforced plastic is inserted into a substantially tubular-shaped connection portion having a tapered male screw portion on its external surface so that the connection portion is fixed to the end portion.

Meanwhile, as described above, when pipes made from fiber reinforced plastic are used for, for example, pumping crude oil from an oil well, many pipes are connected to one another via couplings in the vertical direction, so that a very large tensile load is exerted on each pipe. At this time, screw threads of a tapered male screw portion that is provided on an end of the pipe are pressed by screw threads of a tapered female screw portion of the coupling, and a force directed toward a central axis side of the pipe is exerted on a front-end of the pipe. As a result, the entire circumference of the front-end of the pipe is bent toward the central axis side, and compression stress of the pipe in the circumferential direction increases, possibly causing deformation (buckling in the circumferential direction) or breakage at the front-end of the pipe.

### SUMMARY OF INVENTION

The present invention is directed to a pipe, and it is an object thereof to suppress deformation or breakage of a front-end of the pipe caused by a tensile load or the like.

A pipe according to the present invention includes: a pipe main body that has a tubular shape centered on a central axis and is made from fiber reinforced plastic; and a connection portion that is a member having a substantially tubular shape centered on the central axis and being made from a resin, and into which an end portion of the pipe main body is inserted, thereby being fixed to the end portion, wherein the connection portion includes a cover portion that has an annular shape and covers an end face of the pipe main body; and a tapered male screw portion that is provided on an external surface thereof at a position further than the end face toward another end face side, and when the pipe main body is connected to another pipe main body, the tapered male screw portion is screwed with a tapered female screw portion that is provided on an internal surface of a coupling that has a substantially tubular shape.

According to the present invention, it is possible to suppress deformation or breakage of a front-end of a pipe caused by a tensile load or the like.

In a preferable embodiment of the present invention, a distance between the end face of the pipe main body and a front-end portion of the tapered male screw portion in a direction of the central axis is at least one and a half times as long as a pitch between screw threads of the tapered male screw portion. Accordingly, it is possible to suppress deformation or breakage of the front-end of the pipe more reliably.

In another preferable embodiment of the present invention, an external surface of the end portion of the pipe main body includes a main body inclined surface whose diameter is gradually reduced toward the end face, and an internal surface of the connection portion includes an opposing inclined surface whose diameter is gradually reduced toward the cover portion, and that is to be bonded to the main body inclined surface. As a result, it is easily possible to provide the tapered male screw portion while reducing the thickness of the connection portion.

The pipe is preferably used for pumping crude oil from an oil well.

The above-described object and other objects, features, embodiments, and advantages are apparent from the following detailed description of the present invention with reference to the accompanied drawings.

### BRIEF DESCRIPTION OF DRAWINGS

FIG. 1 illustrates pipes and a coupling.

FIG. 2 is a cross-sectional view illustrating a pipe and the coupling.

FIG. 3 is a perspective view illustrating the pipe and the coupling.

FIG. 4 is a cross-sectional view illustrating a pipe and a coupling of a comparative example.

FIG. 5 is a diagram illustrating deformation that occurs on a front-end of the pipe of the comparative example.

FIG. 6 is a graph illustrating a relationship of the circumferential direction stress exerted on a front-end of a pipe to the extension length.

FIG. 7A is a perspective view illustrating the pipe.

FIG. 7B is a perspective view illustrating the pipe of the comparative example.

FIG. 8 is a graph illustrating a relationship of the amount of strain to the tightening torques.

### DESCRIPTION OF EMBODIMENTS

FIG. 1 illustrates pipes 1 according to an embodiment of the present invention, and FIG. 1 specifically illustrates two pipes 1 that are connected to each other by a coupling 5. The pipe 1 and the coupling 5 have tubular shapes with their centers on a central axis J1. The pipes 1 are used for, for example, pumping crude oil from an oil well and, in this case, a number of pipes 1 are connected to each other via the couplings 5 in the vertical direction. The pipes 1 may be used for underground carbon dioxide storage, water desalination facilities, hot springs, geothermal electric power plants, and the like.

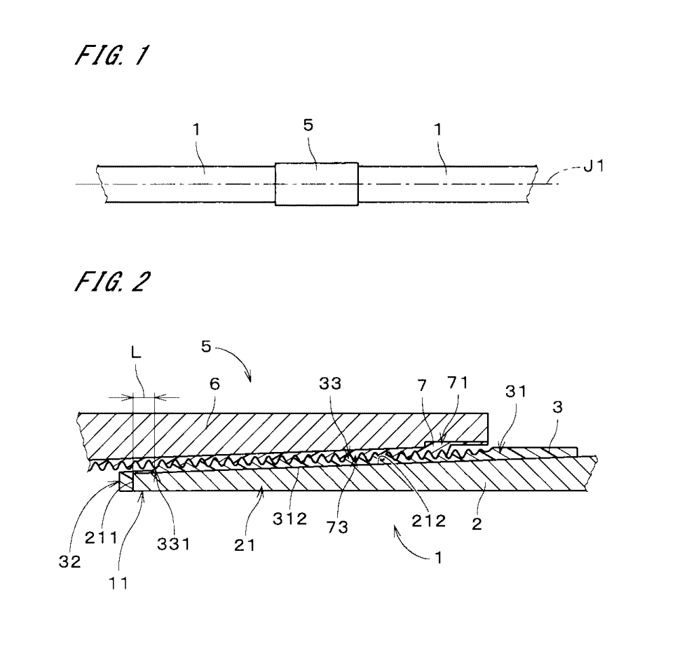

FIG. 2 is a cross-sectional view of the pipe 1 and the coupling 5, and specifically illustrates part of a cross-section that includes the central axis J1 of the pipe 1 and the coupling 5 (the portion that corresponds to the upper side of FIG. 1). The pipe 1 includes a pipe main body 2 that is made from fiber reinforced plastic, and two connection portions 3 that are provided respectively on both end portions of the pipe main body 2 (in FIG. 2, only one connection portion 3 is shown). Since the two connection portions 3 have the same shape, in the following description, attention will be given only to the connection portion 3 that is provided on one end portion 21 of the pipe main body 2.

The connection portion 3 is a member that is made from a resin and has a substantially tubular shape centered on the central axis J1 (see FIG. 1). The pipe main body 2 has a tubular shape centered on the central axis J1, and the end portion 21 of the pipe main body 2 is inserted into the connection portion 3 so that the connection portion 3 is fixed to the end portion 21. Reinforced fiber or a matrix resin of the fiber reinforced plastic of the pipe main body 2 may be any of various known materials. Also, a resin from which the connection portion 3 is made may be any of various known materials.

The connection portion 3 includes: a connection portion main body 31 that has a substantially tubular shape; an annular cover portion 32 that covers an end face 211 of the pipe main body 2 at an edge of the connection portion main body 31; and a tapered male screw portion 33 that is formed on an external surface of the connection portion main body 31. An internal surface of the connection portion main body 31 has an inclined surface 312 whose diameter is gradually reduced toward the cover portion 32 (that is, toward the end face 211 of the pipe main body 2). An external surface of the end portion 21 of the pipe main body 2 also has an inclined surface 212 (hereinafter referred to as “main body inclined surface 212”) whose diameter is gradually reduced toward the end face 211, and the inclined surface 312 of the connection portion main body 31 opposes the main body inclined surface 212 of the pipe main body 2 and is bonded to the main body inclined surface 212 (for example, they are bonded together with the matrix resin of the pipe main body 2 or the resin from which the connection portion 3 is made). Hereinafter, the inclined surface 312 of the connection portion main body 31 is referred to as “opposing inclined surface 312”.

The external surface of the connection portion main body 31 is also an inclined surface (circular conical surface) whose diameter is gradually reduced toward the cover portion 32, and screw threads are formed along the inclined surface, and thus the tapered male screw portion 33 is formed. The connection portion 3 is provided with the tapered male screw portion 33, which is located apart from a cover portion 32 at the front-end of the connection portion main body 31 toward the other end of the connection portion main body 31 in a direction of the central axis J1 (in the lateral direction in FIG. 2). In other words, the connection portion 3 is provided with the tapered male screw portion 33 at a position further than the end face 211 of the pipe main body 2 toward the other end face side. In FIG. 2, a length between the front-end portion 331 (that is, the end portion on the cover portion 32 side) of the tapered male screw portion 33 and the end face 211 of the pipe main body 2 (hereinafter, referred to as “extension length”) is indicated by an arrow with reference numeral L. Hereinafter, a portion 11 of the pipe 1 that is located further than the tapered male screw portion 33 (that is, a portion including the front-end of the pipe main body 2 and the cover portion 32) is referred to as “front-end protrusion portion 11”.

The main body inclined surface 212 of the pipe main body 2 is formed by grinding an external surface of an end portion of a tubular-shaped member that is intended to serve as the pipe main body 2, for example. Although reinforced fiber of the fiber reinforced plastic that constitute the pipe main body 2 is exposed at the end face 211 and the main body inclined surface 212 of the pipe main body 2, in the pipe 1 as has already been described, the end face 211 and the main body inclined surface 212 are respectively covered with the cover portion 32 and the opposing inclined surface 312 of the connection portion 3, thus preventing degradation of the reinforced fiber due to fluid flowing through the pipe 1, exfoliation of the reinforced fiber and the matrix resin, and the like. Note that in a region on an internal surface side of the pipe main body 2, the matrix resin is present with a certain thickness so as to form a corrosion-resistant layer.

The coupling 5 includes a coupling main body 6 made from fiber reinforced plastic, and a connection portion 7 that is made from a resin and has a substantially tubular shape centered on the central axis J1. The connection portion 7 is provided on an internal surface of the coupling main body 6 that has a substantially tubular shape centered on the central axis J1. The connection portion 7 includes a connection portion main body 71 that has a substantially tubular shape, and a tapered female screw portion 73 is formed on an internal surface of each end portion of the connection portion main body 71 in the direction of the central axis J1 (in the lateral direction in FIG. 2). Reinforced fiber and a matrix resin of fiber reinforced plastic of the coupling main body 6 may be any of various known materials. Also, the resin from which the connection portion 7 is made may also be any of various known materials.

When connecting one pipe 1 to another pipe 1, that is, when connecting one pipe main body 2 to another pipe main body 2, a tapered male screw portion 33 at one end portion 21 of one pipe main body 2 is screwed with one tapered female screw portion 73 that is provided on the internal surface of the coupling 5, and a tapered male screw portion 33 at one end portion 21 of the other pipe main body 2 is screwed with the other tapered female screw portion 73 of the coupling 5.

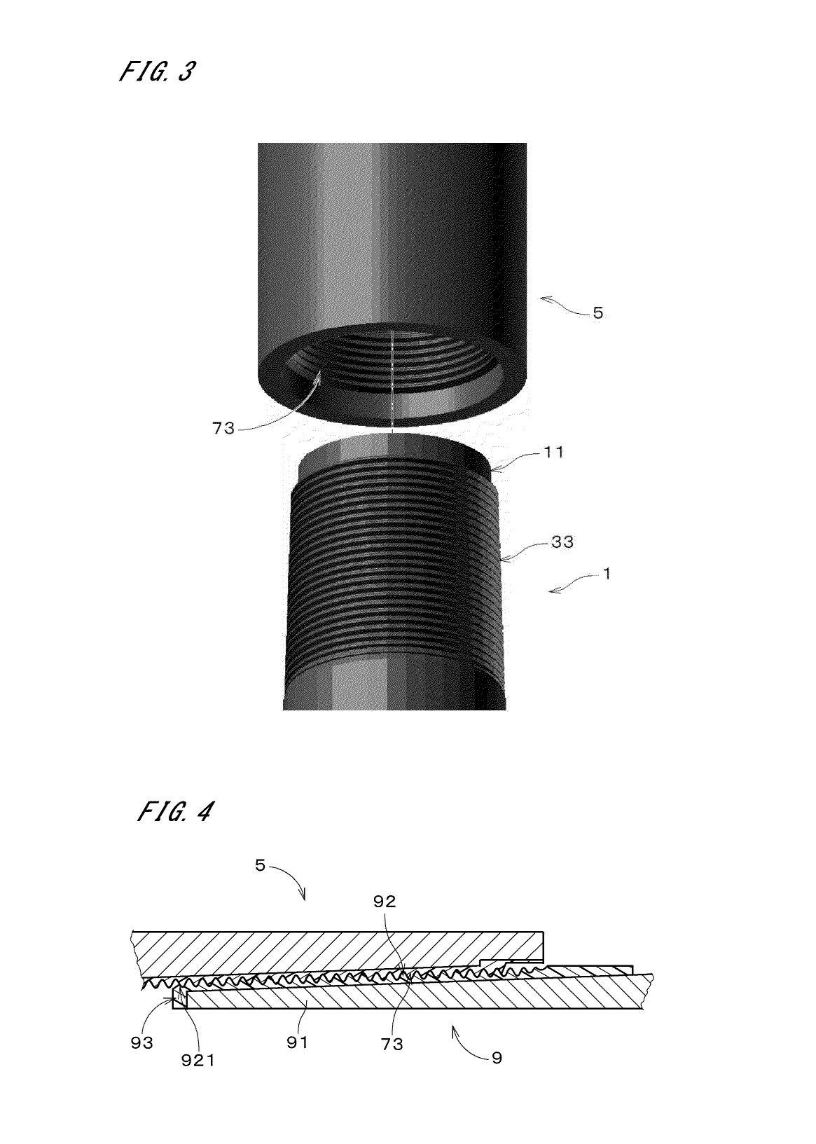

At this time, as illustrated in FIG. 3, the front-end protrusion portion 11, which is a portion located further than the tapered male screw portion 33 of the pipe 1 toward the front-end side, is inserted into the tapered female screw portion 73, and then the tapered male screw portion 33 is tightened with respect to the tapered female screw portion 73. In other words, the front-end protrusion portion 11 achieves a guide mechanism for approximately matching the central axis of the pipe 1 with the central axis of the coupling 5, enabling the tightening operation of the tapered male screw portion 33 to be easily performed. Also, the presence of the front-end protrusion portion 11 prevents the tapered male screw portion 33 from strongly colliding with the coupling 5 and from being broken. Note that the tapered male screw portion 33 is tightened with respect to the tapered female screw portion 73 in a relative manner, and either one of the pipe 1 and the coupling 5 may be rotated.

FIG. 4 is a cross-sectional view of a pipe 9 of a comparative example and the coupling 5, and illustrates a cross-section including the central axes of the pipe 9 and the coupling 5. In the pipe 9 of the comparative example, a front-end portion 921 of a tapered male screw portion 92 is located at the position not overlapping a pipe main body 91 in a direction perpendicular to the central axis (in the vertical direction in FIG. 4). In other words, the front-end portion 921 is located at the position overlapping the cover portion 93. Other configurations are equivalent to the configurations of the pipe 1 in FIG. 2.

When many pipes 9 of the comparative example are connected to one another via couplings 5 in the vertical direction, a very large tensile load is exerted on each pipe 9. At this time, screw threads of the tapered male screw portion 92 provided at an end of the pipe 9 of the comparative example are pressed by screw threads of the tapered female screw portion 73 of the coupling 5, and a force that is directed toward the central axis side (on the lower portion of the pipe 9 shown in FIG. 4) is exerted on the entire circumferential region of the end portion of the pipe 9. As a result, as illustrated in FIG. 5, the entire circumferential region of the pipe 9 in the vicinity of the front-end portion 921 of the tapered male screw portion 92 is bent toward the central axis side, and compression stress in the circumferential direction increases at this region. In this case, deformation of the front-end of the pipe 9 (buckling in the circumferential direction) or breakage may occur, possibly causing fluid flowing through the pipe 9 to leak out of the vicinity of the front-end of the pipe 9 (that is, the sealing property is deteriorated).

In contrast, in the pipe 1 in FIG. 2, the tapered male screw portion 33 is provided at a position further than the end face 211 of the pipe main body 2 toward the other end face side, and the relatively long front-end protrusion portion 11 is formed at a position further than the front-end portion 331 of the tapered male screw portion 33. Accordingly, the entire circumferential region of the pipe 1 in the vicinity of the front-end portion 331 is reinforced by the tubular front-end protrusion portion 11, and bending of this region toward the central axis J1 side (strain of this portion) is suppressed when a tensile load is exerted on the pipe 1, and the compression stress in the circumferential direction is reduced in the region in the vicinity of the front-end portion 331, as compared with that of the pipe 9 of the comparative example. As a result, it is possible to suppress deformation (buckling in the circumferential direction) and breakage of the front-end of the pipe 1, and to prevent leak of fluid out of the vicinity of the front-end of the pipe 1 from occurring. Note that in the pipe 9 of the comparative example, bending load occurring in the vicinity of the front-end portion 921 is entirely applied to the region in the vicinity of the front-end portion 921, whereas in the pipe 1, it can be considered that the bending load is shared among regions of the front-end protrusion portion 11.

Meanwhile, in the pipe 9 of the comparative example, a tubular-shaped front-end protrusion portion is supposed to be formed at a position further than the front-end portion 921 of the tapered male screw portion 92 toward the front-end side by increasing the thickness (the length in the central axis direction, which is the lateral direction in FIG. 4) of the cover portion 93 that covers the end face of the pipe main body 91. In this case, however, since this front-end protrusion portion is made only from a resin, it is not possible to increase the strength of the front-end protrusion portion itself to a large extent. In contrast, in the pipe 1 in FIG. 2, the front-end protrusion portion 11 includes a region of the pipe main body 2 that is made from the fiber reinforced plastic. Accordingly, it is possible to increase the strength of the front-end protrusion portion 11, enabling deformation or breakage of the front-end of the pipe 1 to be suppressed reliably.

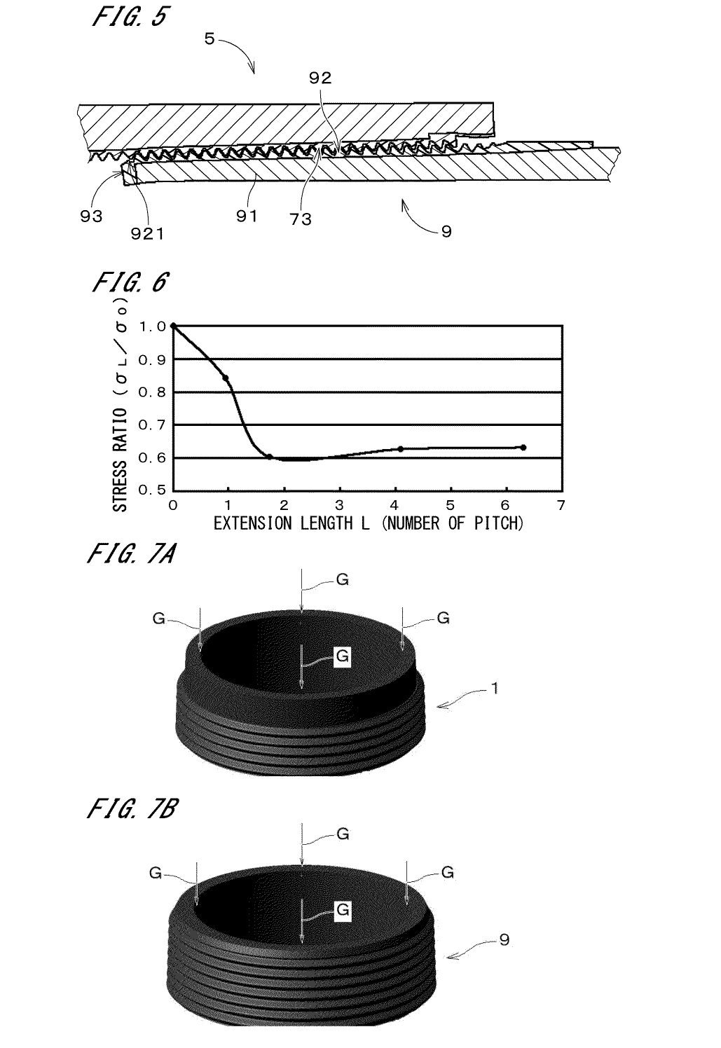

The following will describe a relationship of the extension length L (see FIG. 2) between the front-end portion 331 of the tapered male screw portion 33 and the end face 211 of the pipe main body 2, to the stress that occurs at the front-end of the pipe 1 when a predetermined tensile load is applied to the pipe 1 and the coupling 5. FIG. 6 is a diagram illustrating a relationship of the circumferential direction stress that occurs at the front-end of the pipe to the extension length L. The vertical axis in FIG. 6 indicates stress ratios (σL/σ0) of circumferential direction stresses σL for a plurality of extension lengths L to the circumferential direction stress σ0 when the extension length L is 0, and the lateral axis indicates values each obtained by dividing the extension length L by a pitch between screw threads of the tapered male screw portion 33. Note that the pipe 1 has an internal diameter of 60 mm and an external diameter (excluding the end portion 21) of 77 mm.

It is apparent from FIG. 6 that a stress ratio (σL/σ0) becomes constant at approximately 0.6 when the extension length L is at least one and a half times as long as the pitch between screw threads of the tapered male screw portion 33. Therefore, in order to suppress deformation or breakage of the front-end of the pipe 1 more reliably, it is preferable that a distance (that is, the extension length L) between the front-end portion 331 of the tapered male screw portion 33 and the end face 211 of the pipe main body 2 in the direction of the central axis J1 be at least one and a half times as long as the pitch between screw threads of the tapered male screw portion 33.

For example, American Petroleum Institute sets a standard for the number of screw threads per unit length, namely, it is set that the number of screw threads per one inch length in the central axis direction of the pipe is ten when the external diameter of the pipe is smaller than two inches (50.8 millimeter (mm)), and the number of screw threads per one inch length in the central axis direction is eight when the external diameter of the pipe is two inches or greater. The pipe 1 conforms to the standard set by American Petroleum Institute and the external diameter thereof is 77 mm, so that the number of screw threads per one inch length in the central axis direction is eight. Thus, if an external diameter of a pipe is two inches or greater, a pitch between screw threads is the same as that of the pipe 1, and similarly it can be said that an extension length L is preferably at least one and a half times as long as the pitch between screw threads. Actually, the pipe main body 2 and the connection portion 3 at any angular position centered on the central axes have approximately the same cross-sectional shapes (that is, a cross-sectional shape showing one side taking the central axis as a border, as illustrated in FIG. 2) whatever size the external diameter of the pipe has, and therefore it is assumed to be preferable that, irrespective of the size of the pipe, the extension length L be at least one and a half times as long as the pitch between screw threads. Note that in view of easy handling of the pipe 1, it is preferable that the extension length L be at most ten times as long as a pitch between screw threads of the tapered male screw portion 33.

Next, taking into consideration the actual environment of use, a sheet-shaped heater was wound around two pipes and one coupling in which the pipes are connected to each other via the coupling (see FIG. 1), and heated so that an internal surface thereof has a temperature of 100° C. These connection members were subjected to a tensile load of 173 kilonewton (kN), and then the presence or absence of deformation or the like of the front-ends of the pipes was tested. Whereas a crack extending in the central axis direction (so-called vertical crack) occurred in a front-end of the pipe in the case where the pipes 9 of the comparative example were used, no deformation or breakage occurred on the front-end of the pipe in the case where the pipes 1 including the front-end protrusion portion 11 were used.

Also, when high temperature fluid flows through pipes and couplings are cooled by outside air, heat expansion at the tapered male screw portions is limited by the tapered female screw portion of the coupling, resulting in compression stress (thermal stress) in the circumferential direction at the front-end of the pipe (in the vicinity of the front-end portion of the tapered male screw portion). Even in such a case, deformation or breakage at the pipe front-end of the pipe 1 including the front-end protrusion portion 11 is suppressed.

In the case of the pipe 9 of the comparative example in FIG. 4, deformation or breakage may occur at the front-end of the pipe 9 also when the tapered male screw portion 92 is strongly tightened with respect to the tapered female screw portion 73 of the coupling 5. The following will describe relationships of the tightening torque applied to the coupling 5 by each of the pipe 1 and the pipe 9 of the comparative example to the amount of strain that occurs at each front-end of the pipes 1 and 9. Here, as illustrated in FIGS. 7A and 7B, strain gauges were installed at four positions with an angular interval of 90 degrees, with their centers on the central axis of the pipe (the positions shown by arrows with reference numeral G in FIGS. 7A and 7B, and to be exact, positions that are 5 mm apart from the front-ends), on the internal surfaces in the vicinity of the respective front-ends of the pipe 1 and the pipe 9 of the comparative example. Then, while the coupling 5 was fixed using a pipe wrench, the pipe 1 and the pipe 9 of the comparative example were rotated using a torque wrench and tightened with a plurality types of tightening torques, and thereby amounts of strain in the four strain gauges were measured. Note that as with the above-described case, the pipe 1 and the pipe 9 of the comparative example have each an internal diameter of 60 mm and an external diameter (excluding the end portion) of 77 mm.

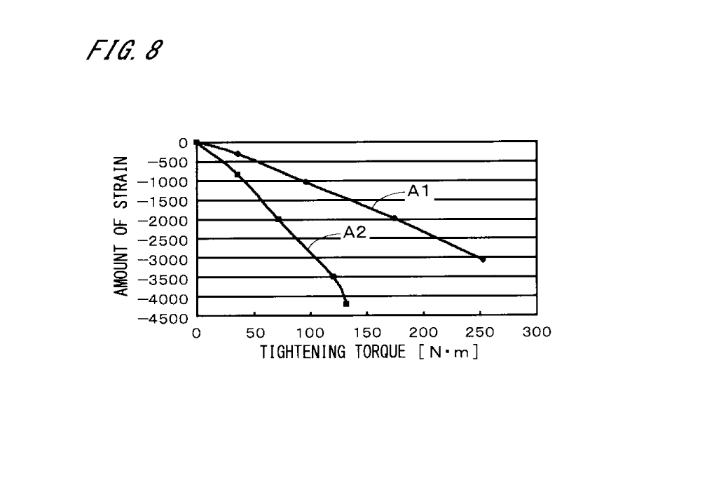

FIG. 8 is a diagram illustrating a relationship of the average of the amounts of strain at four strain gauges to the tightening torques applied using a torque wrench. In FIG. 8, the amounts of strain of the pipe 1 are indicated by a line with reference numeral A1, and the amounts of strain of the pipe 9 of the comparative example are indicated by a line with reference numeral A2. It is apparent from FIG. 8 that when tightening torques of the same value are applied to the pipe 1 and the pipe 9 of the comparative example, the amount of strain of the pipe 1 is smaller (that is, stress is smaller) than the amount of strain of the pipe 9 of the comparative example. Therefore, it can be said that the pipe 1 can suppress deformation or breakage of the front-end of the pipe caused when the pipe 1 is tightened with respect to the coupling 5, as compared with the pipe 9 of the comparative example.

Although the embodiment of the present invention has been described so far, the present invention is not limited to the embodiment, and various modifications are possible.

The internal surface of the connection portion 3 may have a constant diameter, and in this case, the end portion 21 of the pipe main body 2 whose external diameter is constant is inserted into the connection portion 3, and the connection portion 3 is fixed to the end portion 21. On the other hand, as shown in FIG. 2, in the pipe 1, in which the main body inclined surface 212 that is provided on the end portion 21 of the pipe main body 2 and the opposing inclined surface 312 provided on the internal surface of the connection portion 3 are bonded together, it is easily possible to provide the tapered male screw portion 33 while reducing the thickness of the connection portion 3.

Although the pipes 1 are particularly suitable for use in a circumstance at elevated pressure and temperature in which a high corrosion resistance property is required, as in the case of use for pumping crude oil from an oil well, the pipes 1 may, of course, be used in other circumstances than the above-described circumstance.

The configurations of the above-described embodiments and the various modifications may suitably be combined with each other, as long as they are mutually consistent.

Although the present invention has been described in detail, the descriptions having already been made are illustrative and not limiting. Therefore, it can be said that many modifications and modes are possible without departing from the scope of the present invention.

### REFERENCE SIGNS LIST

1 Pipe
2 Pipe main body
3 Connection portion
5 Coupling
21 End portion
32 Cover portion
33 Tapered male screw portion
73 Tapered female screw portion
211 End face
212 Main body inclined surface
312 Opposing inclined surface
331 Front-end portion
J1 Central axis
L Extension length LISTING OF THE CLAIMS

1. A pipe comprising:
a pipe main body that has a tubular shape centered on a central axis and is made from fiber reinforced plastic; and
a connection portion that is a member having a substantially tubular shape centered on the central axis and being made from a resin, and into which an end portion of the pipe main body is inserted, thereby being fixed to the end portion,
wherein the connection portion includes a cover portion that has an annular shape and covers an end face of the pipe main body; and a tapered male screw portion that is provided on an external surface thereof at a position further than the end face toward another end face side, and
when the pipe main body is connected to another pipe main body, the tapered male screw portion is screwed with a tapered female screw portion that is provided on an internal surface of a coupling having a substantially tubular shape.

2. The pipe according to claim 1,
wherein a distance between the end face of the pipe main body and a front-end portion of the tapered male screw portion in a direction of the central axis is at least one and a half times as long as a pitch between screw threads of the tapered male screw portion.

3. The pipe according to claim 1,
wherein an external surface of the end portion of the pipe main body includes a main body inclined surface whose diameter is gradually reduced toward the end face, and an internal surface of the connection portion includes an opposing inclined surface whose diameter is gradually reduced toward the cover portion, and that is to be bonded to the main body inclined surface.

4. The pipe according to claim 1, used for pumping crude oil from an oil well.

5. The pipe according to claim 2, used for pumping crude oil from an oil well.

6. The pipe according to claim 3, used for pumping crude oil from an oil well.

7. The pipe according to claim 2,
wherein an external surface of the end portion of the pipe main body includes a main body inclined surface whose diameter is gradually reduced toward the end face, and an internal surface of the connection portion includes an opposing inclined surface whose diameter is gradually reduced toward the cover portion, and that is to be bonded to the main body inclined surface.

8. The pipe according to claim 7, used for pumping crude oil from an oil well.
